(19) United States
(12) Patent Application Publication
(10) Pub. No.: US 2006/0037017 A1
(43) Pub. Date: Feb. 16, 2006

(54) System, apparatus and method of reducing adverse performance impact due to migration of processes from one CPU to another

(75) Inventors: Jos Manuel Accapadi, Austin, TX (US); Larry Bert Brenner, Austin, TX (US); Andrew Dunshea, Austin, TX (US); Dirk Michel, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation, Armonk, NY (US)

(21) Appl. No.: 10/916,985

(22) Filed: Aug. 12, 2004

(51) Int. Cl. G06F 9/46

(52) U.S. Cl. 718/100

(57) ABSTRACT

A system, apparatus and method of reducing adverse performance impact due to migration of processes from one processor to another in a multi-processor system are provided. When a process is executing, the number of cycles it takes to fetch each instruction (CPI) of the process is stored. After execution of the process, an average CPI is computed and stored in a storage device that is associated with the process. When a run queue of the multi-processor system is empty, a process may be chosen from the run queue that has the most processes awaiting execution to migrate to the empty run queue. The chosen process is the process that has the highest average number of CPIs.

### CROSS-REFERENCE TO RELATED APPLICATIONS

This application is related to co-pending U.S. patent application Ser. No. ______ (IBM Docket No. AUS920040033), entitled SYSTEM, APPLICATION AND METHOD OF REDUCING CACHE THRASHING IN A MULTI-PROCESSOR WITH A SHARED CACHE ON WHICH A DISRUPTIVE PROCESS IS EXECUTING, filed on even date herewith and assigned to the common assignee of this application, the disclosure of which is herein incorporated by reference.

### BACKGROUND OF THE INVENTION

1. Technical Field

The present invention is directed to resource allocations in a computer system. More specifically, the present invention is directed to a system, apparatus and method of reducing adverse performance impact due to migration of processes from one CPU to another.

2. Description of Related Art

At any given processing time, there may be a multiplicity of processes or threads waiting to be executed on a processor or CPU of a computing system. To best utilize the CPU of the system then, it is necessary that an efficient mechanism that properly queues the processes or threads for execution be used. The mechanism used by most computer systems to accomplish this task is a scheduler.

Note that a process is a program. When a program is executing, it is loosely referred to as a task. In most operating systems, there is a one-to-one relationship between a task and a program. However, some operating systems allow a program to be divided into multiple tasks or threads. Such systems are called multithreaded operating systems. For the purpose of simplicity, threads and processes will henceforth be used interchangeably.

A scheduler is a software program that coordinates the use of a computer system's shared resources (e.g., a CPU). The scheduler usually uses an algorithm such as a first-in, first-out (i.e., FIFO), round robin or last-in, first-out (LIFO), a priority queue, a tree etc. algorithm or a combination thereof in doing so. Basically, if a computer system has three CPUs (CPU₁, CPU₂ and CPU₃), each CPU will accordingly have a ready-to-be-processed queue or run queue. If the algorithm in use to assign processes to the run queue is the round robin algorithm and if the last process created was assigned to the queue associated with CPU₂, then the next process created will be assigned to the queue of CPU₃. The next created process will then be assigned to the queue associated with CPU₁ and so on. Thus, schedulers are designed to give each process a fair share of a computer system's resources.

In certain instances, however, it may be more efficient to bind a process to a particular CPU. This may be done to optimize cache performance. For example, for cache coherency purposes, data is kept in only one CPU's cache at a time. Consequently, whenever a CPU adds a piece of data to its local cache, any other CPU in the system that has the data in its cache must invalidate the data. This invalidation may adversely impact performance since a CPU has to spend precious cycles invalidating the data in its cache instead of executing processes. But, if the process is bound to one CPU, the data may never have to be invalidated.

In addition, each time a process is moved from one CPU (i.e., a first CPU) to another CPU (i.e., a second CPU), the data that may be needed by the process will not be in the cache of the second CPU. Hence, when the second CPU is processing the process and requests the data from its cache, a cache miss will be generated. A cache miss adversely impacts performance since the CPU has to wait longer for the data. After the data is brought into the cache of the second CPU from the cache of the first CPU, the first CPU will have to invalidate the data in its cache, further reducing performance.

Note that when multiple processes are accessing the same data, it may be more sensible to bind all the processes to the same CPU. Doing so guarantees that the processes will not contend over the data and cause cache misses.

Thus, binding processes to CPUs may at times be quite beneficial.

When a CPU executes a process, the process establishes an affinity to the CPU since the data used by the process, the state of the process etc. are in the CPU's cache. This is referred to as CPU affinity. There are two types of CPU affinity: soft and hard. In hard CPU affinity, the scheduler will always schedule a particular process to run on a particular CPU. Once scheduled, the process will not be rescheduled to another CPU even if the CPU is busy while other CPUs are idle. By contrast in soft CPU affinity, the scheduler will first schedule the process to run on a CPU. If, however, the CPU is busy while others are idle, the scheduler may reschedule the process to run on one of the idle CPUs. Thus, soft CPU affinity may sometimes be more efficient than hard CPU affinity.

However, since when a process is moved from one CPU to another, performance may be adversely affected, a system, apparatus and method are needed to circumvent or reduce any adverse performance impact that may ensue from moving a process from one CPU to another as is customary in soft CPU affinity.

### SUMMARY OF THE INVENTION

The present invention provides a system, apparatus and method of reducing adverse performance impact due to migration of processes from one processor to another in a multi-processor system. When a process is executing, the number of cycles it takes to fetch each instruction (CPI) of the process is stored. After execution of the process, an average CPI is computed and stored in a storage device that is associated with the process. When a run queue of the multi-processor system is empty, a process may be chosen from the run queue that has the most processes awaiting execution to migrate to the empty run queue. The chosen process is the process that has the highest average number of CPIs.

In one embodiment, the number of cycles it takes to fetch each piece of data is stored in the storage device rather than the average CPI. This number is averaged out at the end of the execution of the process and the average is used to select a process to migrate from a run queue having the highest number of processes awaiting execution to an empty run queue.

In another embodiment, both average CPI and cycles per data are used in determining which process to migrate. Particularly, when processes that are instruction-intensive are being executed, the average CPI is used. If instead data-intensive processes are being executed, the average number of cycles per data is used. In cases where processes that are neither data-intensive nor instruction-intensive are being executed, both the average CPI and the average number of cycles per data are used.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a multi-processor system according to the present invention.

FIG. 2a depicts run queues of the multi-processor system with assigned processes.

FIG. 2b depicts the run queues after some processes have been dispatched for execution.

FIG. 2c depicts the run queues after some processes have received their processing quantum and have been reassigned to the respective run queues of the processors that have executed them earlier.

FIG. 2d depicts the run queues after some time has elapsed.

FIG. 2e depicts the run queue of one of the processors empty.

FIG. 2f depicts the run queues after one process has been moved from run queue to another run queue.

FIG. 3 is a flowchart of a first process that may be used by the invention.

FIG. 4 is a flowchart of a second process that may be used by the invention.

FIG. 5 is a flowchart of a process that may be used to reassign a thread from one CPU to another CPU.

### DETAILED DESCRIPTION OF THE PREFERRED EMBODIMENT

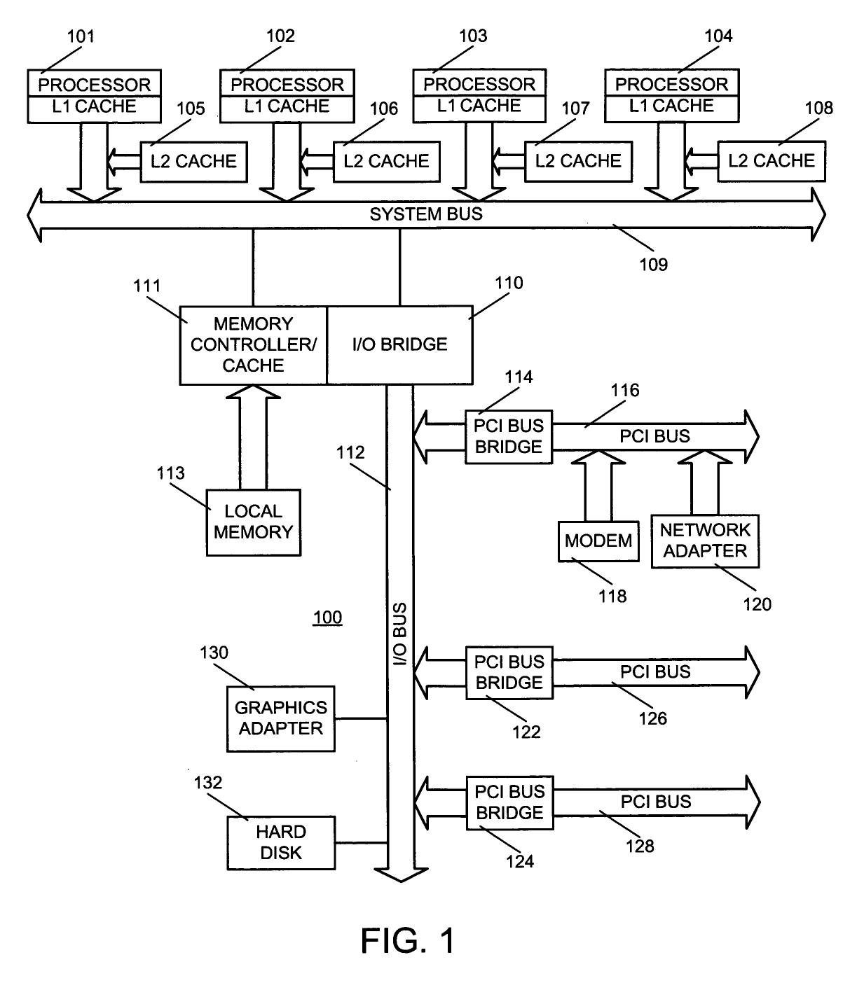

FIG. 1 is a block diagram of an exemplary multi-processor system in which the present invention may be implemented. The exemplary multi-processor system may be a symmetric multi-processor (SMP) architecture and is comprised of a plurality of processors (101, 102, 103 and 104), which are each connected to a system bus 109. Interposed between the processors and the system bus 109 are two respective caches (integrated L1 caches and L2 caches 105, 106, 107 and 108), though many more levels of caches are possible (i.e., L3, L4 etc. caches). The purpose of the caches is to temporarily store frequently accessed data and thus provide a faster communication path to the cached data in order to provide faster memory access.

Connected to system bus 109 is memory controller/cache 111, which provides an interface to shared local memory 109. I/O bus bridge 110 is connected to system bus 109 and provides an interface to I/O bus 112. Memory controller/cache 111 and I/O bus bridge 110 may be integrated as depicted.

Peripheral component interconnect (PCI) bus bridge 114 connected to I/O bus 112 provides an interface to PCI local bus 116. A number of modems may be connected to PCI local bus 116. Typical PCI bus implementations will support four PCI expansion slots or add-in connectors. Communications links to a network may be provided through modem 118 and network adapter 120 connected to PCI local bus 116 through add-in boards.

Additional PCI bus bridges 122 and 124 provide interfaces for additional PCI local buses 126 and 128, from which additional modems or network adapters may be supported. In this manner, data processing system 100 allows connections to multiple network computers. A memory-mapped graphics adapter 130 and hard disk 132 may also be connected to I/O bus 112 as depicted, either directly or indirectly.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 1 may be, for example, an IBM e-Server pSeries system, a product of International Business Machines Corporation in Armonk, N.Y., running the Advanced Interactive Executive (AIX) operating system or LINUX operating system.

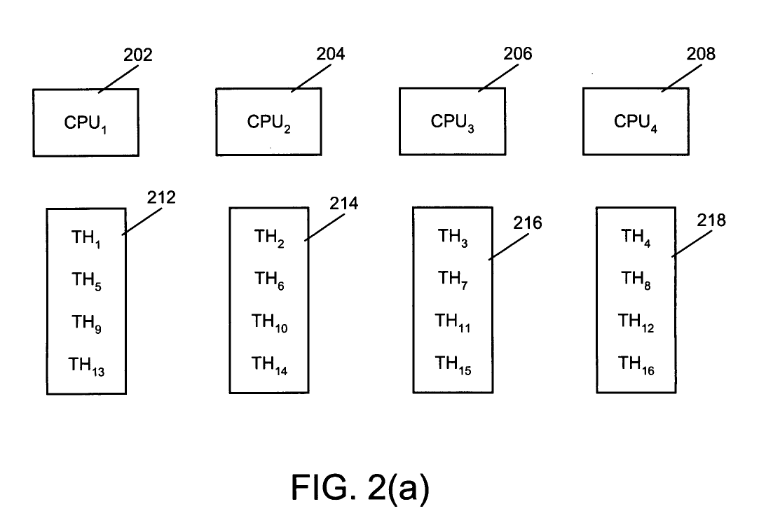

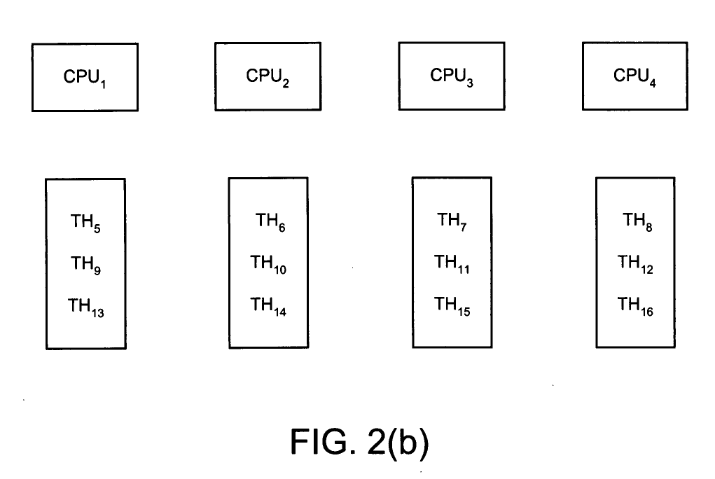

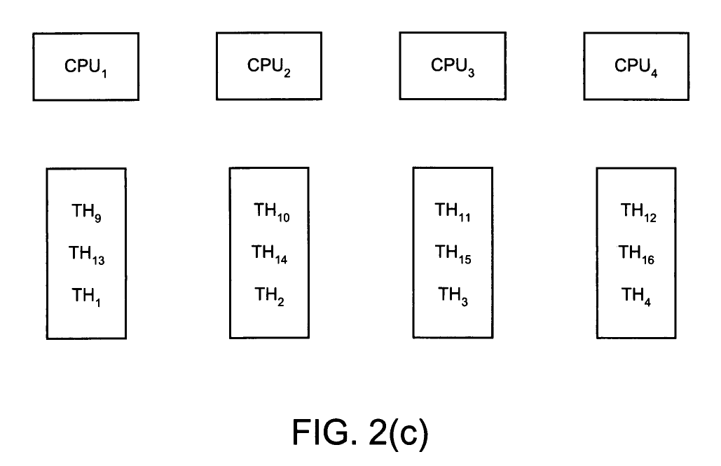

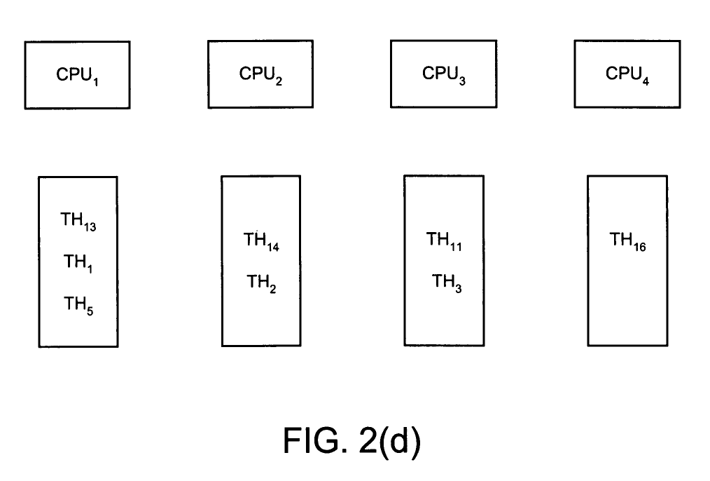

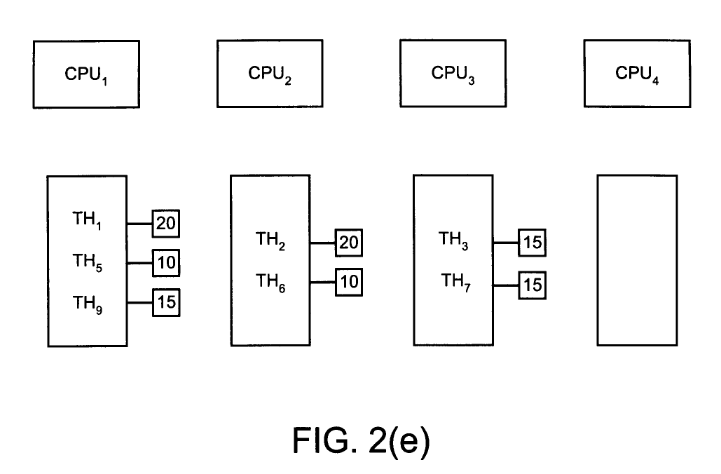

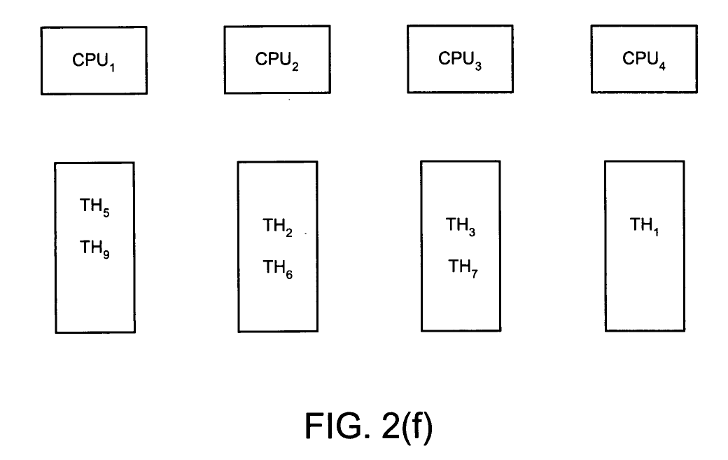

The operating system generally includes a scheduler, a global run queue, one or more per-processor local run queues, and a kernel-level thread library. In this case, since only the per-processor run queues are needed to explain the invention only those will be shown. FIG. 2a depicts the four processors of the multi-processor system each having a local run queue. The local run queue of the first processor (CPU₁ 202), the second processor (CPU₂ 204), the third processor (CPU₃ 206) and the fourth processor (CPU₄ 208) is run queues 212, 214, 216 and 218, respectively.

According to the content of the run queues, the scheduler has already assigned threads Th₁, Th₅, Th₉ and Th₁₃ to CPU₁ 202. Threads Th₂, Th₆, Th₁₀ and Th₁₄ have been assigned to CPU₂ 204 while threads Th₃, Th₇, Th₁₁, and Th₁₅ have been assigned to CPU₃ 206 and threads Th₄, Th₈, Th₁₂ and Th₁₆ has been assigned to CPU₄ 208.

In order to inhibit one thread from preventing other threads from running on an assigned CPU, each thread has to take turns running on the CPU. Thus, another duty of the scheduler is to assign units of CPU time (e.g., quanta or time slices) to threads. A quantum is typically very short in duration, but threads receive quanta so frequently that the system appears to run smoothly, even when many threads are performing work.

Every time one of the following situations occurs, the scheduler must make a CPU scheduling decision: a thread's quantum on the CPU expires, a thread waits for an event to occur and a thread becomes ready to execute. In order not to obfuscate the disclosure of the invention, only the case where a thread's quantum on the CPU expires will be explained. However, it should be understood that the invention may apply to the other two cases equally.

Suppose, Th₁, Th₂, Th₃ and Th₄ are dispatched for execution by CPU₁, CPU₂, CPU₃ and CPU₄, respectively. Then the run queue of each CPU will be as shown in FIG. 2b. When a thread's quantum expires, the scheduler executes a FindReadyThread algorithm to decide whether another thread needs to take over the CPU. Hence, after Th₁, Th₂, Th₃ and Th₄ have exhausted their quantum, the scheduler may run the FindReadyThread algorithm to find Th₅, Th₆, Th₇ and Th₈. Those threads will be dispatched for execution.

Since Th₁ ran on CPU₁ then any data as well as instructions that it may have used while being executed will be in the integrated L1 cache of processor 101 of FIG. 1. The data will also be in L2 cache 105. Likewise, any data and instructions used by Th₂ during execution will be in the integrated L1 cache of processor 102 as well as in associated L2 cache 106. Data and instructions used by Th₃ and Th₄ will likewise be in integrated L2 cache of processors 103 and 104, respectively, as well as their associated L2 caches 107 and 108. Hence the threads will have developed some affinity to the respective CPU on which they ran. Due to this affinity, the scheduler will re-assign each thread to run on that particular CPU. Hence FIG. 2c depicts the run queue of each CPU after threads Th₅, Th₆, Th₇ and Th₈ have been dispatched and threads Th₁, Th₂, Th₃ and Th₄ have been reassigned to their respective CPU.

Suppose after some time has elapsed and after some threads have terminated etc. the run queues of the CPUs are populated as shown in FIG. 2d. In FIG. 2d, the run queue of CPU₁ is shown to have three threads (Th₁, Th₅ and Th₉) while the run queue of both CPU₂ and CPU₃ has two threads (Th₂ and Th₆ and Th₃ and Th₇, respectively) and the run queue of CPU₄ has one thread (Th₁₆). Thus, after Th₁₆ has terminated and if no new threads are assigned to CPU₄, CPU₄ will then become idle. Suppose further that while CPU₄ is idle, CPU₁ still has three threads assigned thereto (see FIG. 2e). At this point, the scheduler may want to reassign one of the four threads assigned to CPU₁ to CPU₄.

According to the invention, after a thread has run on a CPU, some statistics about the execution of the thread may be saved in the thread's structure. For example, the number of instructions that were found in the caches (i.e., L1, L2 etc.) as well as RAM 109 may be entered in the thread's structure. Likewise the number of pieces of data found in the caches and RAM is also stored in the thread's structure. Further, the number of cache misses that occurred (for both instruction and data) during the execution of the thread may be recorded as well. Using these statistics, a CPI (cycles per instruction) may be computed. The CPI reveals the cache efficiency of the thread when executed on that particular CPU.

The CPI may be used to determine which thread from a group of threads in a local run queue to reassign to another local run queue. Particularly, the thread with the highest CPI may be re-assigned from one CPU to another with the least adverse impact on performance since that thread already had a low cache efficiency. Returning to FIG. 2e, Th₁ is shown to have a CPI of 20 while Th₅ a CPI of 10 and Th₉ a CPI of 15. Then, from the three threads in the run queue of CPU₁, Th₁ may have the least adverse affect on performance if it is reassigned. Consequently, Th₁ may be reassigned from CPU₁ to CPU₄. Note that if a thread needed to be reassigned from the run queue of CPU₂ to CPU₄, Th₂ would be the one chosen as it is the least cache efficient thread in the run queue of CPU₂. In the case of the threads in the run queue of CPU₃, either Th₃ or Th₇ may be chosen since they both have the CPI.

FIG. 2f depicts the run queues of the CPUs after thread Th₁ is reassigned to CPU₄.

In some instances, instead of using the CPI number to determine which thread to migrate from one queue to another run queue, a different number may be used. For example, in cases where instruction-intensive threads are being executed, the instruction cache efficiency of the thread may be used (i.e., the number of CPU cycles it takes for the CPU to obtain an instruction from storage). Likewise, in cases where data-intensive threads are being executed, the data cache efficiency of the thread may be used (i.e., the number of CPU cycles it takes the CPU to obtain data from storage).

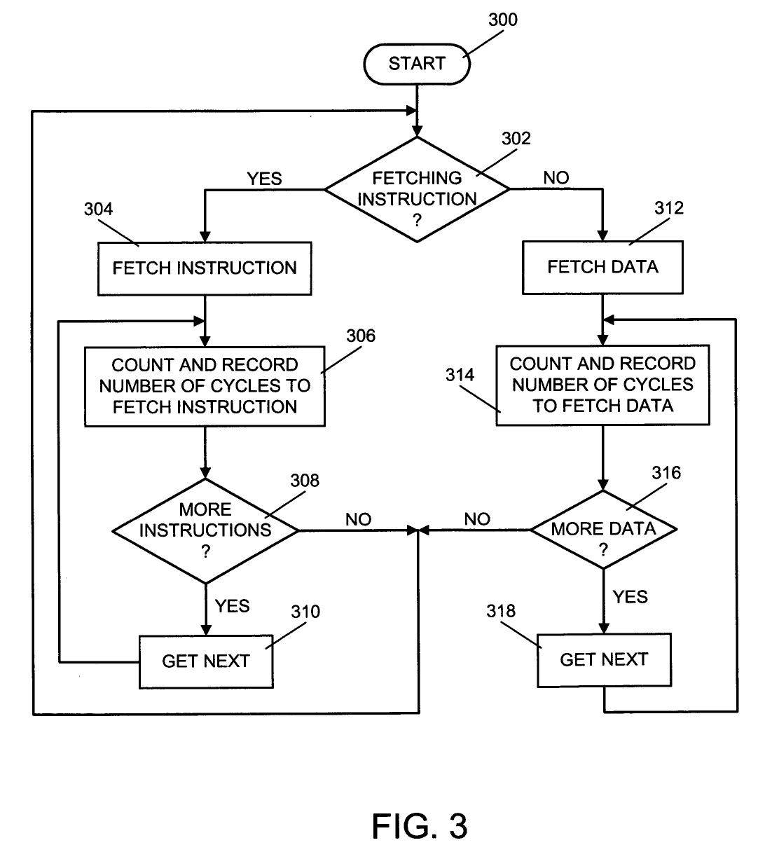

FIG. 3 is a flowchart of a first process that may be used by the invention. The process starts when a thread is being executed (step 300). Then a check is made to determine whether an instruction is being fetched (step 302). If so, the instruction is fetched while the number of cycles it actually takes to obtain the instruction is recorded. If there are more instructions to fetch, the next one is fetched. If not, the process returns to step (steps 304, 306, 308 and 310).

If data is to be fetched instead of instructions, the first piece of data will be fetched (step 312). As the data is being fetched, the number of cycles it actually takes to obtain the data will be counted and recorded. If there is more data to fetch the next piece of data will be fetched otherwise the process will return to step 302. The process ends when execution of the thread has terminated (steps 314, 316 and 318).

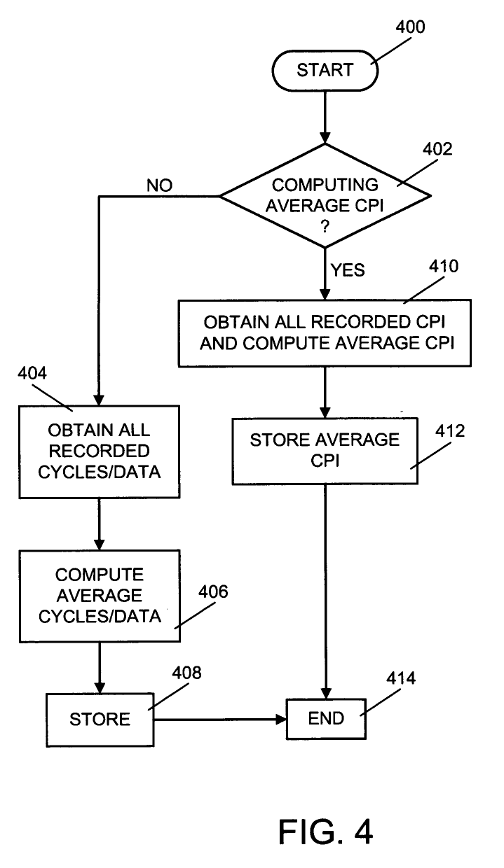

FIG. 4 is a flowchart of a second process that may be used by the present invention. This process starts after execution of the thread has terminated (step 400). At that time, the average number of cycles per instruction as well as the average number of cycles per data is computed and stored in the thread structure (steps 402-414).

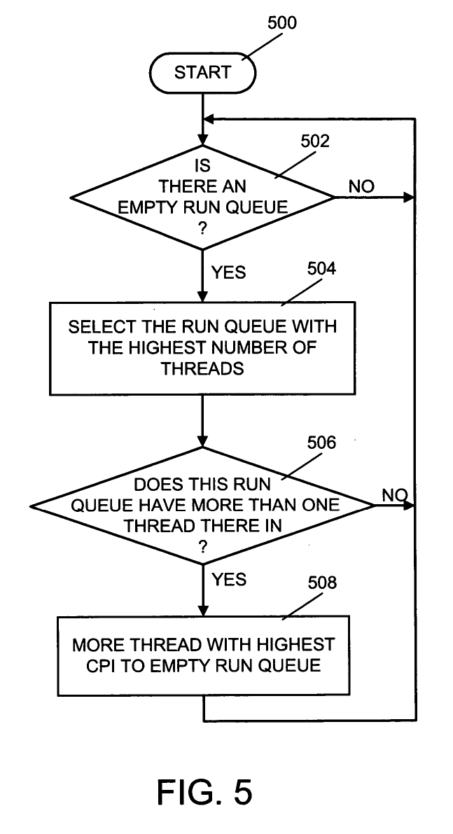

FIG. 5 is a flowchart of a process that may be used to reassign a thread from one CPU to another CPU. The process starts when a computer system on which the process is executing is turned on or is reset (step 500). Then a check is made to determine whether there is a CPU with an empty run queue in the system. If so, a search is made for the CPU with the highest number of threads in its run queue. If the number of threads in the run queue of the CPU with the highest number of threads in its run queue is more than one then the thread with the highest CPI is moved to the empty run queue. The process ends when the computer system is turned off (steps 502, 504, 506 and 508).

The description of the present invention has been presented for purposes of illustration and description, and is not intended to be exhaustive or limited to the invention in the form disclosed. Many modifications and variations will be apparent to those of ordinary skill in the art. For example, threads of fixed priorities may be used rather than of variable priorities. Thus, the embodiment was chosen and described in order to best explain the principles of the invention, the practical application, and to enable others of ordinary skill in the art to understand the invention for various embodiments with various modifications as are suited to the particular use contemplated.

What is claimed is:

1. A method of reducing adverse performance impact due to migration of processes from one processor to another in a multi-processor system, each processor having a run queue, the method comprising the steps of:
executing a process, the process having a storage device associated therewith in which data pertaining to the process is stored;
counting and storing, while executing the process, the number of cycles it takes to fetch each instruction (CPI);
computing, using the stored CPIs, an average CPI after execution of the process;
storing the computed average CPI in the storage device;
determining whether a run queue is empty;
determining, if a run queue is empty, the run queue with the highest number of processes;
choosing a process from the run queue with the highest number of processes to migrate to the empty run queue, the chosen process having the highest stored CPI; and
migrating the chosen process to the empty run queue.

2. The method of claim 1 wherein the number of cycles it takes to fetch each piece of data during execution of the process is counted and stored averaged out and the average used to determine the process to migrate.

3. The method of claim 1 wherein the number of cycles it takes to fetch each piece of data during execution of the process is counted and stored averaged out and the average used, in conjunction with the average CPI, to determine the process to migrate.

4. The method of claim 3 wherein only the average CPI is used during execution of instruction-intensive processes.

5. The method of claim 3 wherein only the average cycle per data is used during execution of data-intensive processes.

6. A computer program product on a computer readable medium for reducing adverse performance impact due to migration of processes from one processor to another in a multi-processor system, each processor having a run queue, the computer program product comprising:
program code means for executing a process, the process having a storage device associated therewith in which data pertaining to the process is stored;
program code means for counting and storing, while executing the process, the number of cycles it takes to fetch each instruction (CPI);
program code means for computing, using the stored CPIs, an average CPI after execution of the process;
program code means for storing the computed average CPI in the storage device;
program code means for determining whether a run queue is empty;
program code means for determining, if a run queue is empty, the run queue with the highest number of processes;
program code means for choosing a process from the run queue with the highest number of processes to migrate to the empty run queue, the chosen process having the highest stored CPI; and
program code means for migrating the chosen process to the empty run queue.

7. The computer program product of claim 6 wherein the number of cycles it takes to fetch each piece of data during execution of the process is counted and stored averaged out and the average used to determine the process to migrate.

8. The computer program product of claim 6 wherein the number of cycles it takes to fetch each piece of data during execution of the process is counted and stored averaged out and the average used, in conjunction with the average CPI, to determine the process to migrate.

9. The computer program product of claim 8 wherein only the average CPI is used during execution of instruction-intensive processes.

10. The computer program product of claim 8 wherein only the average cycle per data is used during execution of data-intensive processes.

11. An apparatus for reducing adverse performance impact due to migration of processes from one processor to another in a multi-processor system, each processor having a run queue, the apparatus comprising:
means for executing a process, the process having a storage device associated therewith in which data pertaining to the process is stored;
means for counting and storing, while executing the process, the number of cycles it takes to fetch each instruction (CPI);
means for computing, using the stored CPIs, an average CPI after execution of the process;
means for storing the computed average CPI in the storage device;
means for determining whether a run queue is empty;
means for determining, if a run queue is empty, the run queue with the highest number of processes;
means for choosing a process from the run queue with the highest number of processes to migrate to the empty run queue, the chosen process having the highest stored CPI; and
means for migrating the chosen process to the empty run queue.

12. The apparatus of claim 11 wherein the number of cycles it takes to fetch each piece of data during execution of the process is counted and stored averaged out and the average used to determine the process to migrate.

13. The apparatus of claim 11 wherein the number of cycles it takes to fetch each piece of data during execution of the process is counted and stored averaged out and the average used, in conjunction with the average CPI, to determine the process to migrate.

14. The apparatus of claim 13 wherein only the average CPI is used during execution of instruction-intensive processes.

15. The apparatus of claim 13 wherein only the average cycle per data is used during execution of data-intensive processes.

16. A multi-processor system for reducing adverse performance impact due to migration of processes from one processor to another, each processor having a run queue, the multi-processor system comprising:
at least one storage device for storing code data; and
at least two processors for processing the code data to execute processes, the processes having a storage device associated therewith in which data pertaining to the processes is stored, to count and store, while executing the processes, the number of cycles it takes to fetch each instruction (CPI), to compute, using the stored CPIs, an average CPI after execution of the process, to store the computed average CPI in the storage device, to determine whether a run queue is empty, to determine, if a run queue is empty, the run queue with the highest number of processes, to choose a process from the run queue with the highest number of processes to migrate to the empty run queue, the chosen process having the highest stored CPI, and to migrate the chosen process to the empty run queue.

17. The multi-processor system of claim 16 wherein the number of cycles it takes to fetch each piece of data during execution of the process is counted and stored averaged out and the average used to determine the process to migrate.

18. The multi-processor system of claim 16 wherein the number of cycles it takes to fetch each piece of data during execution of the process is counted and stored averaged out and the average used, in conjunction with the average CPI, to determine the process to migrate.

19. The multi-processor system of claim 18 wherein only the average CPI is used during execution of instruction-intensive processes.

20. The multi-processor system of claim 18 wherein only the average cycle per data is used during execution of data-intensive processes.
